(19) United States
(12) Patent Application Publication
(10) Pub. No.: US 2017/0171021 A1
(43) Pub. Date: Jun. 15, 2017

(54) AUTOMATIC DEPLOYMENT OF A NEW SERVER IN A PEER-TO-PEER NETWORK OF SERVERS

(71) Applicant: Lenovo Enterprise Solutions (Singapore) Pte. Ltd., Singapore (SG)

(72) Inventors: Srihari V. Angaluri, Raleigh, NC (US); Gary D. Cudak, Wake Forest, NC (US); Ajay Dholakia, Cary, NC (US); Chulho Kim, Poughkeepsie, NY (US)

(21) Appl. No.: 14/963,956

(22) Filed: Dec. 9, 2015

(51) Int. Cl. H04L 12/24; G06F 9/445; H04L 29/08

(52) U.S. Cl. CPC H04L 41/0806; H04L 67/34; H04L 67/1074; G06F 8/61

(57) ABSTRACT

A method includes detecting that a new server has connected to an existing peer-to-peer network including a plurality of servers, forming a multicast group of servers that includes the new server and at least a first server from among the plurality of servers, downloading an operating system kernel to the new server from one or more of the plurality of servers, obtaining a hardware configuration of the new server, assigning a role to the new server based on the hardware configuration of the new server, and identifying an operating system image to be installed on the new server based on the assigned role. Preferably, the new server will then download and install the identified operating system image and joint the peer-to-peer network in the assigned role. One of the servers is able assign the role to the new server using predetermined deployment policies that are accessible to the servers.

### BACKGROUND

Field of the Invention

The present invention relates to deploying a new server in a peer-to-peer network.

Background of the Related Art

Typically, in a cloud or data center environment with hundreds of servers, the initial deployment and management of servers requires a considerable amount of time and resources. When new servers are added to the existing cloud environment, a series of initial setup steps have to be executed in order to configure and add the new server into the environment. There are a variety of tools available in the marketplace today to assist with server deployment.

Existing utilities for server deployments are driven by specific servers acting as the management/deployment servers and a system administrator or a cloud deployment engineer manually adding a new server into the environment by pre-configuring the environment with the right parameters, such as server media access control (MAC) addresses for preboot execution environment (PXE) booting, or local disk configuration for redundant array of independent disks (RAID).

### BRIEF SUMMARY

One embodiment of the present invention provides a method comprising detecting that a new server has connected to an existing peer-to-peer network including a plurality of servers, forming a multicast group of servers that includes the new server and at least a first server from among the plurality of servers, downloading an operating system kernel to the new server from one or more of the plurality of servers, obtaining a hardware configuration of the new server, assigning a role to the new server based on the hardware configuration of the new server, and identifying an operating system image to be installed on the new server based on the assigned role.

Another embodiment of the present invention provides a computer program product comprising a non-transitory computer readable storage medium having program instructions embodied therewith, the program instructions executable by a processor to cause the processor to perform a method. The method comprises detecting that a new server has connected to an existing peer-to-peer network including a plurality of servers, forming a multicast group of servers that includes the new server and at least a first server from among the plurality of servers, downloading an operating system kernel to the new server from one or more of the plurality of servers, obtaining a hardware configuration of the new server, assigning a role to the new server based on the hardware configuration of the new server, and identifying an operating system image to be installed on the new server based on the assigned role.

### BRIEF DESCRIPTION OF THE SEVERAL VIEWS OF THE DRAWINGS

FIG. 1 is a diagram of a group of servers in a network and a new server being added to the network.

FIG. 2 is a table illustrating the content of deployment policies according to one embodiment of the present invention.

FIG. 3 is a diagram of a server.

FIG. 4 is a flowchart of a method according to one embodiment of the present invention.

### DETAILED DESCRIPTION

One embodiment of the present invention provides a method comprising detecting that a new server has connected to an existing peer-to-peer network including a plurality of servers, forming a multicast group of servers that includes the new server and at least a first server from among the plurality of servers, downloading an operating system kernel to the new server from one or more of the plurality of servers, obtaining a hardware configuration of the new server, assigning a role to the new server based on the hardware configuration of the new server, and identifying an operating system image to be installed on the new server based on the assigned role.

Downloading the operating system kernel allows a network file system to be mounted or an additional local file system to be downloaded, and the complete operating system can be fully initialized. Accordingly, downloading the operating system kernel to the new server is an initial step in adding the new server to the peer-to-peer network.

The new server may be assigned any role that a server may play in the peer-to-peer network. For example, the new server may be assigned to a role selected from compute node, storage, management, or user/login. The operating system image that is installed on the new server is identified based upon the role assigned to the new server. Accordingly, an operating system image that is specific to the assigned role is downloaded and installed on the new server so that the new server will function in the assigned role.

In a peer-to-peer network, there is no one central management entity or server that manages the operations of the network, such as the setup of an additional server. Embodiments of the present invention allow the addition of a new server to a peer-to-peer network, without administrator intervention, by allowing one or more of the plurality of servers in the existing peer-to-peer network to make decisions about the role that should be assigned and the operating system that should be downloaded to the new server. For example, a role may be assigned to the new server by one of the plurality of servers that has access to deployment policies, where such deployment policies associate a server role and an operating system image with a plurality of attributes of a server hardware configuration. The deployment policies may be predetermined by a network administrator. Optionally, the plurality of attributes may, without limitation, be selected from memory capacity, number of hard disk drives, and type of network adapter. It is not necessary for every server in the peer-to-peer network to have access to the deployment policies, so long as at least one of the servers in the multicast group has access. If a first one of the plurality of servers in the existing peer-to-peer network has access to the deployment policies, then the first server may perform the steps of obtaining a hardware configuration of the new server, assigning a role to the new server based on the hardware configuration of the new server, and identifying an operating system image to be installed on the new server. The hardware configuration of the new server is preferably obtained by the new server transmitting the hardware configuration to other servers in the multicast group.

The operating system kernel and the operating system image are both downloaded to the new server from one or more nodes of the peer-to-peer network. These nodes may include one of the plurality of servers in the existing peer-to-peer network and/or a shared network storage device, such as network attached storage. In one specific option, the operating system kernel is downloaded to the new server from one of the plurality of servers, and the operating system image is downloaded from a shared network storage device. In one example, the operating system kernel is a lightweight operating system kernel such as Linux. Optionally, the operating system kernel may include a tracker that identifies nodes from which a desired file, such as the operating system image, may be downloaded. Accordingly, the new server may make requests for data from any one or more of the nodes of the peer-to-peer network.

The method preferably further includes downloading the identified operating system image to the new server, and installing the identified operating system image on the new server. Accordingly, the new server may then join the peer-to-peer network with the assigned role.

Another embodiment of the present invention provides a computer program product comprising a non-transitory computer readable storage medium having program instructions embodied therewith, the program instructions executable by a processor to cause the processor to perform a method. The method comprises detecting that a new server has connected to an existing peer-to-peer network including a plurality of servers, forming a multicast group of servers that includes the new server and at least a first server from among the plurality of servers, downloading an operating system kernel to the new server from one or more of the plurality of servers, obtaining a hardware configuration of the new server, assigning a role to the new server based on the hardware configuration of the new server, and identifying an operating system image to be installed on the new server based on the assigned role.

The foregoing computer program products may further include computer readable program code for implementing or initiating any one or more aspects of the methods described herein. Accordingly, a separate description of the methods will not be duplicated in the context of a computer program product.

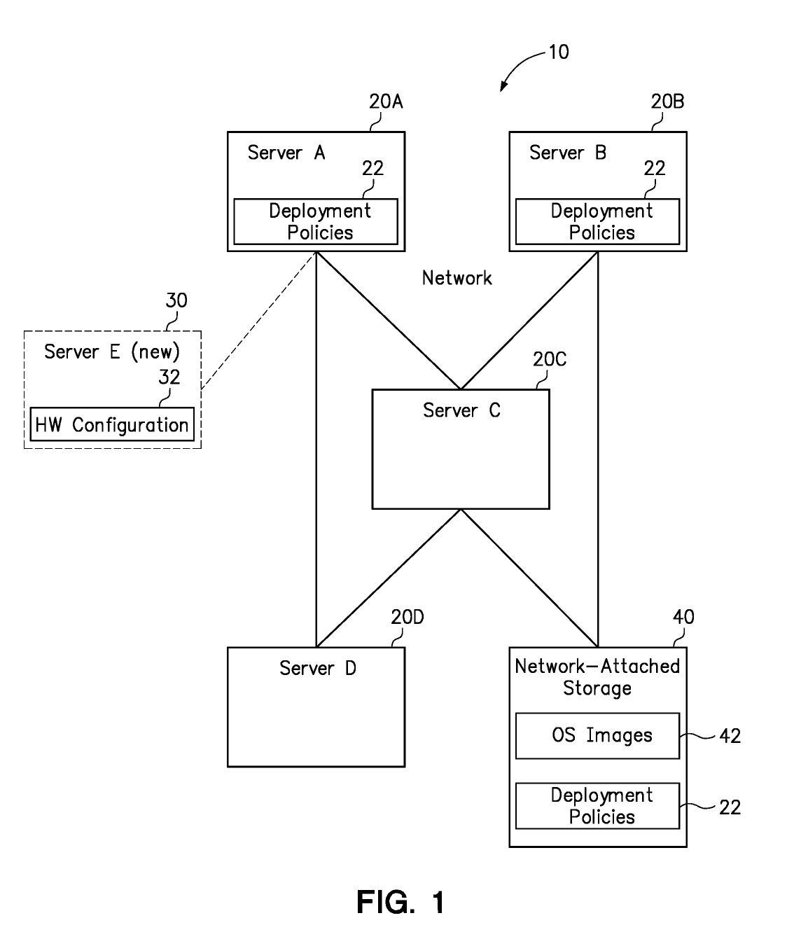

FIG. 1 is a diagram of a peer-to-peer network 10 including a group of servers 20 (individually, servers 20A-20D) that are already in the network and a new server 30 being added to the network 10. The peer-to-peer network 10 is illustrated with a mesh topology, but other peer-to-peer topologies may also be used, such as a fully-connected topology, ring, star, or bus. Accordingly, the servers 20 are able to communication with each other, either directly or making one or more hops between servers. In the example of FIG. 1, the network 10 further includes a network-attached storage device 40, such that each of the servers 20 may also communicate directly or indirectly with the network-attached storage device 40 in order to store and retrieve data from the network-attached storage device 40.

As illustrated, the new server 30 has been connected (see dashed line) to one of the servers 20A (Server A). Accordingly, the new server 30 may obtain a lightweight operating system kernel from the server 20 and provide the hardware configuration 32 to the server 20A. With the hardware configuration information 32 as input and having access to the deployment policies 22, the server 20A may assign a role to the new server 30 and identify an operating system image that should be downloaded to the new server 30. In this example, the network-attached storage device 40 stores various operating system images 42 so that the server 20A may gain access to the identified operating system image and make it available to the new server 30 for downloading. After downloading and installing the operating system image, the new server 30 may join the peer-to-peer network 10 and assume the assigned role. The network may include any number of servers and any number of new servers may be added in accordance with the present invention. This type of “autonomous” server deployment in a peer-to-peer environment will enable quicker deployments and automatic, policy-driven inclusion of new servers to an existing cluster environment without a lot of manual intervention.

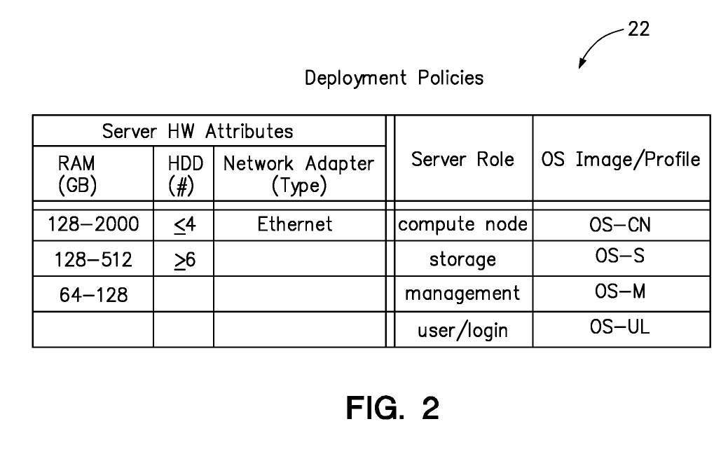

FIG. 2 is a table illustrating the content of deployment policies 22 according to one embodiment of the present invention. On the left side of the table, various server hardware attributes (i.e., the server hardware configuration) are specified, including an amount of random access memory (RAM), a number of hard disk drives (HDD) and a type of network adapter. Using the hardware configuration received from a new server, one of the servers in the existing peer-to-peer network will compare the hardware configuration to the server hardware attributes specified in the deployment policies 22. When the new server hardware configuration satisfies the criteria specified by a particular set (row) of server hardware attributes, then the new server is assigned the corresponding server role and is made to download the corresponding operating system image. For example, if the new server has 256 gigabytes (GB) of physical random access memory (RAM), four 3.5 inch hard disk drives (HDD) having 4 terabytes of storage at 7200 rotations per minute (RPM), and a 40 gigabit (Gb) Ethernet adapter, then its role becomes a “compute node”. Similarly, if the new server has six or more hard disk drives, then the new server is assigned the role of “storage” and is provided with an associated operating system and node profile (i.e., configuration settings associated with the role). Still further, in the present example a new server having 64 GB RAM would be assigned a “management” role. Although the table of deployment policies 22 include blanks, any combination of server hardware attributes, including those shown and those not shown, may be used to identify server hardware attributes that should be associated with a particular server role.

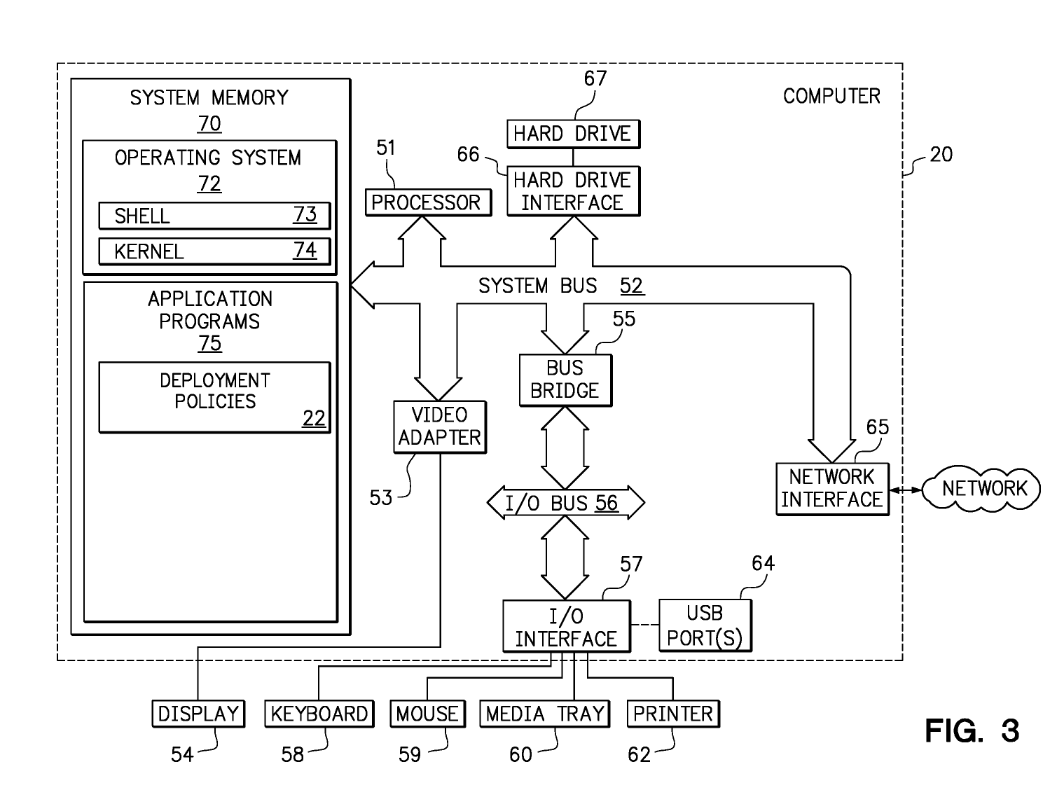

FIG. 3 is a diagram of a computer or server 20 that is capable of implementing the methods of the present invention. The computer 20 includes a processor unit 51 that is coupled to a system bus 52. The processor unit 51 may utilize one or more processors, each of which has one or more processor cores. A video adapter 53, which drives/supports a display 54, is also coupled to the system bus 52. The system bus 52 is coupled via a bus bridge 55 to an input/output (I/O) bus 56. An I/O interface 57 is coupled to the I/O bus 56 and provides communication with various I/O devices, including a keyboard 58, a mouse 59, a media tray 60 (which may include storage devices such as CD-ROM drives, multi-media interfaces, etc.), a printer 62, and USB port(s) 64. As shown, the computer 20 is able to communicate with other network devices, such as other servers, via a network using a network adapter or network interface controller 65.

A hard drive interface 66 is also coupled to the system bus 52. The hard drive interface 66 interfaces with a hard drive 67. In a preferred embodiment, the hard drive 67 communicates with system memory 70, which is also coupled to the system bus 52. System memory includes the lowest level of volatile memory in the computer 20. This volatile memory may include additional higher levels of volatile memory (not shown), including, but not limited to, cache memory, registers and buffers. Data that populates the system memory 70 includes the operating system (OS) 72 and application programs 75.

The operating system 72 includes a shell 73 for providing transparent user access to resources such as application programs 75. Generally, the shell 73 is a program that provides an interpreter and an interface between the user and the operating system. More specifically, the shell 73 executes commands that are entered into a command line user interface or from a file. Thus, the shell 73, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 74) for processing. Note that while the shell 73 is a text-based, line-oriented user interface, the present invention will equally well support other user interface modes, such as graphical, voice, gestural, etc.

As depicted, the operating system 72 also includes the kernel 74, which includes lower levels of functionality for the operating system 72, including providing essential services required by other parts of the operating system 72 and application programs 75, including memory management, process and task management, disk management, and mouse and keyboard management. The application programs 75 in the system memory of the computer 20 may include, without limitation, the deployment policies 22.

The hardware elements depicted in the computer 20 are not intended to be exhaustive, but rather are representative. For instance, the computer 20 may include alternate memory storage devices such as magnetic cassettes, digital versatile disks (DVDs), Bernoulli cartridges, and the like. These and other variations are intended to be within the scope of the present invention.

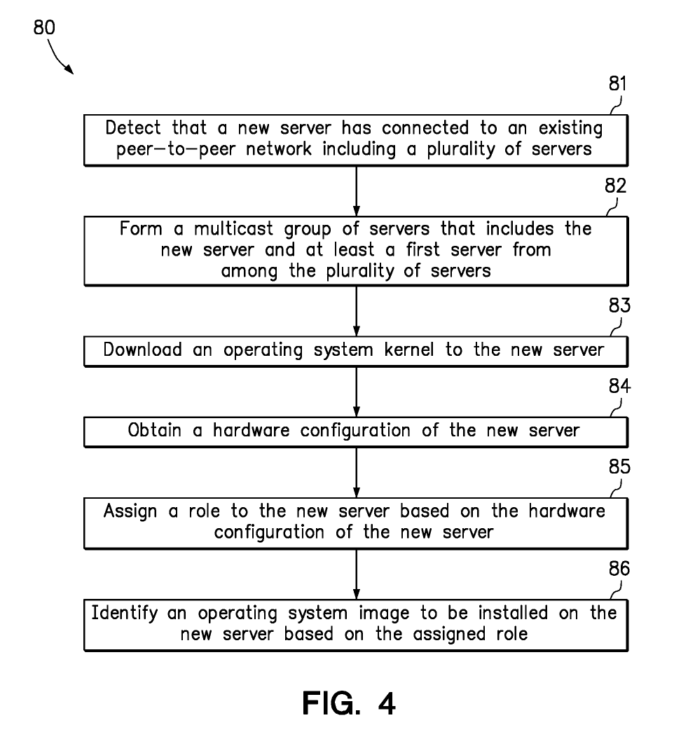

FIG. 4 is a flowchart of a method 80 according to one embodiment of the present invention. In step 81, the method detects that a new server has connected to an existing peer-to-peer network including a plurality of servers. Step 82 forms a multicast group of servers that includes the new server and at least a first server from among the plurality of servers. Step 83 downloads an operating system kernel to the new server and step 84 obtains a hardware configuration of the new server. Then, in step 85, the method assigns a role to the new server based on the hardware configuration of the new server and, in step 86, the method identifies an operating system image to be installed on the new server based on the assigned role.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
detecting that a new server has connected to an existing peer-to-peer network including a plurality of servers;
forming a multicast group of servers that includes the new server and at least a first server from among the plurality of servers;
downloading an operating system kernel to the new server from one or more of the plurality of servers;
obtaining a hardware configuration of the new server;
assigning a role to the new server based on the hardware configuration of the new server; and
identifying an operating system image to be installed on the new server based on the assigned role.

2. The method of claim 1, wherein the operating system kernel is downloaded to the new server from one of the plurality of servers.

3. The method of claim 1, wherein the operating system kernel is Linux.

4. The method of claim 1, further comprising:
downloading the identified operating system image to the new server; and
installing the identified operating system image on the new server.

5. The method of claim 4, further comprising:
the new server joining the peer-to-peer network with the assigned role.

6. The method of claim 4, wherein the identified operating system image is downloaded from a shared network storage device.

7. The method of claim 6, wherein the shared network storage device is network-attached storage.

8. The method of claim 1, wherein the role is assigned to the new server by the one of the plurality of servers.

9. The method of claim 1, further comprising:
accessing deployment policies that associate a server role and an operating system image with a plurality of attributes of a server hardware configuration.

10. The method of claim 9, wherein the plurality of attributes are selected from memory capacity, number of hard disk drives, and type of network adapter.

11. The method of claim 9, wherein the deployment policies are predetermined by a network administrator.

12. The method of claim 9, wherein only a subset of the plurality of servers in the existing peer-to-peer network are configured to access the deployment policies.

13. The method of claim 1, wherein obtaining a hardware configuration of the new server, includes the new server transmitting the hardware configuration to other servers in the multicast group.

14. The method of claim 1, wherein the first server performs the steps of:
obtaining a hardware configuration of the new server;
assigning a role to the new server based on the hardware configuration of the new server; and
identifying an operating system image to be installed on the new server.

15. A computer program product comprising a non-transitory computer readable storage medium having program instructions embodied therewith, the program instructions executable by a processor to cause the processor to perform a method comprising:
detecting that a new server has connected to an existing peer-to-peer network including a plurality of servers;
forming a multicast group of servers that includes the new server and at least a first server from among the plurality of servers;
downloading an operating system kernel to the new server from one or more of the plurality of servers;
obtaining a hardware configuration of the new server;
assigning a role to the new server based on the hardware configuration of the new server; and
identifying an operating system image to be installed on the new server.

16. The computer program product of claim 15, wherein the method further comprises:
downloading the identified operating system image to the new server; and
installing the identified operating system image on the new server.

17. The computer program product of claim 16, wherein the method further comprises:
the new server joining the peer-to-peer network with the assigned role.

18. The computer program product of claim 15, wherein the method further comprises:
accessing deployment policies that associate a server role and an operating system image with a plurality of attributes of a server hardware configuration.

19. The computer program product of claim 18, wherein the plurality of attributes are selected from memory capacity, number of hard disk drives, and type of network adapter.

20. The computer program product of claim 15, wherein the first server performs the steps of:
obtaining a hardware configuration of the new server;
assigning a role to the new server based on the hardware configuration of the new server; and
identifying an operating system image to be installed on the new server.
